(19) United States
(12) Patent Application Publication
(10) Pub. No.: US 2021/0158468 A1
(43) Pub. Date: May 27, 2021

(54) Method for Identifying Individuals Who Are Connected Through a Digital Platform.

(71) Applicant: Edmond Gregoryona, GRANADA HILLS, CA (US)

(72) Inventor: Edmond Gregoryona, GRANADA HILLS, CA (US)

(21) Appl. No.: 17/081,501

(22) Filed: Oct. 27, 2020

Related U.S. Application Data
(60) Provisional application No. 62/939,048, filed on Nov. 22, 2019.

(51) Int. Cl. G06Q 50/30; G06F 16/28; G01C 21/34

(52) U.S. Cl. CPC G06Q 50/30; G01C 21/3438; G06F 16/285

(57) ABSTRACT

A method for enabling users to schedule, and then self-identify during, a rendezvous. The method is performed with a set of user accounts managed by a remote server and associated with a computing (PC) device. The user accounts are divided into initiator accounts and respondent accounts as denoted by an account classifier. The method begins by receiving a rendezvous request from the initiator PC device. The rendezvous request discloses the type and location of the activity for the rendezvous. The method continues by comparing the requested activity to the account classifier of each respondent account to find a matched account. The matched account is then prompted to respond to the rendezvous request and the method plots a course to the location of the rendezvous. At the rendezvous location the initiator and the matched PC devices output a token that enables the initiator and the respondent to identify each other.

The current application claims a priority to the U.S. Provisional Patent application Ser. No. 62/939,048 filed on Nov. 22, 2019.

### FIELD OF THE INVENTION

The present invention generally relates to a notification system. More specifically, the present invention relates to a safety measure for both passengers & drivers who are using ridesharing services.

### BACKGROUND OF THE INVENTION

Based on unfortunate events of people getting into unknown cars and also confusion over locating their ride, a device that notifies the driver and passenger of each other's location is in demand. The ridesharing service relies on nonprofessional drivers, using their own vehicles, connecting with passengers through social interactions and a mobile-device scheduling application. Privately owned individual vehicles provide significant freedom and flexibility, and shared vehicles can be cost-effective, friendly to the environment, and highly convenient. The end result is that passengers can enjoy almost instant service, efficient routes, pre-payment convenience, and highly competitive trip cost compared to conventional taxicab services.

Such shared and on-demand vehicles are especially invaluable to the unsighted, the physically challenged, those too young or too old to drive, and any who want to avoid the problems and expense associated with owning their own personal car. However, certain problems are inherent in using ridesharing services.

Furthermore, within minutes of a person booking a ride using a mobile application, an unfamiliar car can pull up, driven by someone the rider has never met and knows nothing about. The rider may have no indication or description showing what kind of car is arriving, meaning that the person waiting for the ride may not easily identify the ridesharing car. Conversely, the driver of the ridesharing car may also have difficulty identifying the person who is waiting for the car.

A conventional communication method—for example, cell phone or text messages—may not be convenient for a driver in the act of driving, nor for the passenger who may be waiting on the street for the car, without notification of the appearance of the car or the passenger. Such inconvenience may not be solved by verbal communication via a cell phone because of laws prohibiting drivers from using cell phones while driving, for instance. This can be a problem for the elderly, young, or busy people as well as for anyone in a dark place where identifying a car and a person will be more difficult. Thus, there is a need to improve conventional devices for communication between the driver and the passenger who has requested the ride.

The present invention is intended to solve the abovementioned problems through an innovative configuration for a notification system device designed for the driver and the user of a ridesharing service. The present invention can also be used for two individuals to locate each other in a crowd.

### BRIEF DESCRIPTION OF THE DRAWINGS

FIG. 1 is a system diagram of the method of the present invention.

FIG. 2 is a flowchart illustrating the overall method of the present invention.

FIG. 3 is a flowchart illustrating a subprocess for visually outputting the rendezvous token with the initiator and matched PC devices if the distance between the initiator and respondent is less than a desired threshold using the method of the present invention.

FIG. 4 is a flowchart illustrating a subprocess for outputting a real-time location of the matched PC device using the method of the present invention.

FIG. 5 is a flowchart illustrating a subprocess for navigating to a destination using the method of the present invention.

FIG. 6 is a flowchart illustrating a subprocess for visually outputting the rendezvous token with the notification device if the distance between the initiator and respondent is less than a desired threshold using the method of the present invention.

FIG. 7 is a flowchart illustrating a subprocess for enabling the respondent to control the notification device if the distance between the initiator and respondent is less than a desired threshold using the method of the present invention.

FIG. 8 is a flowchart illustrating a subprocess for enabling the initiator to control the notification device if the distance between the initiator and respondent is less than a desired threshold using the method of the present invention.

FIG. 9 is a flowchart illustrating a subprocess for navigating to an agreed upon destination with the initiator and respondent PC devices using the method of the present invention.

FIG. 10 is a flowchart illustrating a subprocess for enabling the initiator and respondent to view each other's avatars using the method of the present invention.

FIG. 11 is a flowchart illustrating a subprocess for enabling the initiator PC device to output an agreed upon initiator token during a rendezvous using the method of the present invention.

FIG. 12 is a flowchart illustrating a subprocess for enabling the match PC device to output an agreed upon initiator token during a rendezvous using the method of the present invention.

FIG. 13 is a flowchart illustrating a subprocess for enabling the initiator to view the profile of the respondent using the method of the present invention.

FIG. 14 is a flowchart illustrating a subprocess for enabling the respondent to view the profile of the respondent using the method of the present invention.

FIG. 15 is a diagram illustrating the components of the computing devices used by the method of the present invention.

### DETAIL DESCRIPTIONS OF THE INVENTION

All illustrations of the drawings are for the purpose of describing selected versions of the present invention and are not intended to limit the scope of the present invention.

As a preliminary matter, it will readily be understood by one having ordinary skill in the relevant art that the present disclosure has broad utility and application. As should be understood, any embodiment may incorporate only one or a plurality of the above-disclosed aspects of the disclosure and may further incorporate only one or a plurality of the above-disclosed features. Furthermore, any embodiment discussed and identified as being “preferred” is considered to be part of a best mode contemplated for carrying out the embodiments of the present disclosure. Other embodiments also may be discussed for additional illustrative purposes in providing a full and enabling disclosure. Moreover, many embodiments, such as adaptations, variations, modifications, and equivalent arrangements, will be implicitly disclosed by the embodiments described herein and fall within the scope of the present disclosure.

Accordingly, while embodiments are described herein in detail in relation to one or more embodiments, it is to be understood that this disclosure is illustrative and exemplary of the present disclosure, and are made merely for the purposes of providing a full and enabling disclosure. The detailed disclosure herein of one or more embodiments is not intended, nor is to be construed, to limit the scope of patent protection afforded in any claim of a patent issuing here from, which scope is to be defined by the claims and the equivalents thereof. It is not intended that the scope of patent protection be defined by reading into any claim limitation found herein and/or issuing here from that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present disclosure. Accordingly, it is intended that the scope of patent protection is to be defined by the issued claim(s) rather than the description set forth herein.

Additionally, it is important to note that each term used herein refers to that which an ordinary artisan would understand such term to mean based on the contextual use of such term herein. To the extent that the meaning of a term used herein—as understood by the ordinary artisan based on the contextual use of such term—differs in any way from any particular dictionary definition of such term, it is intended that the meaning of the term as understood by the ordinary artisan should prevail.

Furthermore, it is important to note that, as used herein, “a” and “an” each generally denotes “at least one,” but does not exclude a plurality unless the contextual use dictates otherwise. When used herein to join a list of items, “or” denotes “at least one of the items,” but does not exclude a plurality of items of the list. Finally, when used herein to join a list of items, “and” denotes “all of the items of the list.”

The following detailed description refers to the accompanying drawings. Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the claims found herein and/or issuing here from. The present disclosure contains headers. It should be understood that these headers are used as references and are not to be construed as limiting upon the subjected matter disclosed under the header.

In general, the method disclosed herein may be performed by one or more computing devices. For example, in some embodiments, the method may be performed by a server computer in communication with one or more client devices over a communication network such as, for example, the Internet. In some other embodiments, the method may be performed by one or more of at least one server computer, at least one client device, at least one network device, at least one sensor and at least one actuator. Examples of the one or more client devices and/or the server computer may include, a desktop computer, a laptop computer, a tablet computer, a personal digital assistant, a portable electronic device, a wearable computer, a smart phone, an Internet of Things (IoT) device, a smart electrical appliance, a video game console, a rack server, a super-computer, a mainframe computer, mini-computer, micro-computer, a storage server, an application server (e.g. a mail server, a web server, a real-time communication server, an FTP server, a virtual server, a proxy server, a DNS server, etc.), a quantum computer, and so on. Further, one or more client devices and/or the server computer may be configured for executing a software application such as, for example, but not limited to, an operating system (e.g. Windows, Mac OS, Unix, Linux, Android, etc.) in order to provide a user interface (e.g. GUI, touch-screen based interface, voice based interface, gesture based interface, etc.) for use by the one or more users and/or a network interface for communicating with other devices over a communication network. Accordingly, the server computer may include a processing device configured for performing data processing tasks such as, for example, but not limited to, analyzing, identifying, determining, generating, transforming, calculating, computing, compressing, decompressing, encrypting, decrypting, scrambling, splitting, merging, interpolating, extrapolating, redacting, anonymizing, encoding and decoding. Further, the server computer may include a communication device configured for communicating with one or more external devices. The one or more external devices may include, for example, but are not limited to, a client device, a third party database, public database, a private database and so on. Further, the communication device may be configured for communicating with the one or more external devices over one or more communication channels. Further, the one or more communication channels may include a wireless communication channel and/or a wired communication channel. Accordingly, the communication device may be configured for performing one or more of transmitting and receiving of information in electronic form. Further, the server computer may include a storage device configured for performing data storage and/or data retrieval operations. In general, the storage device may be configured for providing reliable storage of digital information. Accordingly, in some embodiments, the storage device may be based on technologies such as, but not limited to, data compression, data backup, data redundancy, deduplication, error correction, data finger-printing, role based access control, and so on.

Further, one or more steps of the method disclosed herein may be initiated, maintained, controlled and/or terminated based on a control input received from one or more devices operated by one or more users such as, for example, but not limited to, an end user, an admin, a service provider, a service consumer, an agent, a broker and a representative thereof. Further, the user as defined herein may refer to a human, an animal or an artificially intelligent being in any state of existence, unless stated otherwise, elsewhere in the present disclosure. Further, in some embodiments, the one or more users may be required to successfully perform authentication in order for the control input to be effective. In general, a user of the one or more users may perform authentication based on the possession of a secret human readable secret data (e.g. username, password, passphrase, PIN, secret question, secret answer, etc.) and/or possession of a machine readable secret data (e.g. encryption key, decryption key, bar codes, etc.) and/or or possession of one or more embodied characteristics unique to the user (e.g. biometric variables such as, but not limited to, fingerprint, palm-print, voice characteristics, behavioral characteristics, facial features, iris pattern, heart rate variability, evoked potentials, brain waves, and so on) and/or possession of a unique device (e.g. a device with a unique physical and/or chemical and/or biological characteristic, a hardware device with a unique serial number, a network device with a unique IP/MAC address, a telephone with a unique phone number, a smartcard with an authentication token stored thereupon, etc.). Accordingly, the one or more steps of the method may include communicating (e.g. transmitting and/or receiving) with one or more sensor devices and/or one or more actuators in order to perform authentication. For example, the one or more steps may include receiving, using the communication device, the secret human readable data from an input device such as, for example, a keyboard, a keypad, a touch-screen, a microphone, a camera and so on. Likewise, the one or more steps may include receiving, using the communication device, the one or more embodied characteristics from one or more biometric sensors.

Further, one or more steps of the method may be automatically initiated, maintained and/or terminated based on one or more predefined conditions. In an instance, the one or more predefined conditions may be based on one or more contextual variables. In general, the one or more contextual variables may represent a condition relevant to the performance of the one or more steps of the method. The one or more contextual variables may include, for example, but are not limited to, location, time, identity of a user associated with a device (e.g. the server computer, a client device etc.) corresponding to the performance of the one or more steps, environmental variables (e.g. temperature, humidity, pressure, wind speed, lighting, sound, etc.) associated with a device corresponding to the performance of the one or more steps, physical state and/or physiological state and/or psychological state of the user, physical state (e.g. motion, direction of motion, orientation, speed, velocity, acceleration, trajectory, etc.) of the device corresponding to the performance of the one or more steps and/or semantic content of data associated with the one or more users. Accordingly, the one or more steps may include communicating with one or more sensors and/or one or more actuators associated with the one or more contextual variables. For example, the one or more sensors may include, but are not limited to, a timing device (e.g. a real-time clock), a location sensor (e.g. a GPS receiver, a GLONASS receiver, an indoor location sensor etc.), a biometric sensor (e.g. a fingerprint sensor), an environmental variable sensor (e.g. temperature sensor, humidity sensor, pressure sensor, etc.) and a device state sensor (e.g. a power sensor, a voltage/current sensor, a switch-state sensor, a usage sensor, etc. associated with the device corresponding to performance of the or more steps). Further, the one or more steps of the method may be performed one or more number of times. Additionally, the one or more steps may be performed in any order other than as exemplarily disclosed herein, unless explicitly stated otherwise, elsewhere in the present disclosure. Further, two or more steps of the one or more steps may, in some embodiments, be simultaneously performed, at least in part. Further, in some embodiments, there may be one or more time gaps between performance of any two steps of the one or more steps.

Further, in some embodiments, the one or more predefined conditions may be specified by the one or more users. Accordingly, the one or more steps may include receiving, using the communication device, the one or more predefined conditions from one or more and devices operated by the one or more users. Further, the one or more predefined conditions may be stored in the storage device. Alternatively, and/or additionally, in some embodiments, the one or more predefined conditions may be automatically determined, using the processing device, based on historical data corresponding to performance of the one or more steps. For example, the historical data may be collected, using the storage device, from a plurality of instances of performance of the method. Such historical data may include performance actions (e.g. initiating, maintaining, interrupting, terminating, etc.) of the one or more steps and/or the one or more contextual variables associated therewith. Further, machine learning may be performed on the historical data in order to determine the one or more predefined conditions. For instance, machine learning on the historical data may determine a correlation between one or more contextual variables and performance of the one or more steps of the method. Accordingly, the one or more predefined conditions may be generated, using the processing device, based on the correlation.

Further, one or more steps of the method may be performed at one or more spatial locations. For instance, the method may be performed by a plurality of devices interconnected through a communication network. Accordingly, in an example, one or more steps of the method may be performed by a server computer. Similarly, one or more steps of the method may be performed by a client computer. Likewise, one or more steps of the method may be performed by an intermediate entity such as, for example, a proxy server. For instance, one or more steps of the method may be performed in a distributed fashion across the plurality of devices in order to meet one or more objectives. For example, one objective may be to provide load balancing between two or more devices. Another objective may be to restrict a location of one or more of an input data, an output data and any intermediate data there between corresponding to one or more steps of the method. For example, in a client-server environment, sensitive data corresponding to a user may not be allowed to be transmitted to the server computer. Accordingly, one or more steps of the method operating on the sensitive data and/or a derivative thereof may be performed at the client device.

The present disclosure includes many aspects and features. Moreover, while many aspects and features relate to, and are described in the context of online shopping experience, embodiments of the present disclosure are not limited to use only in this context

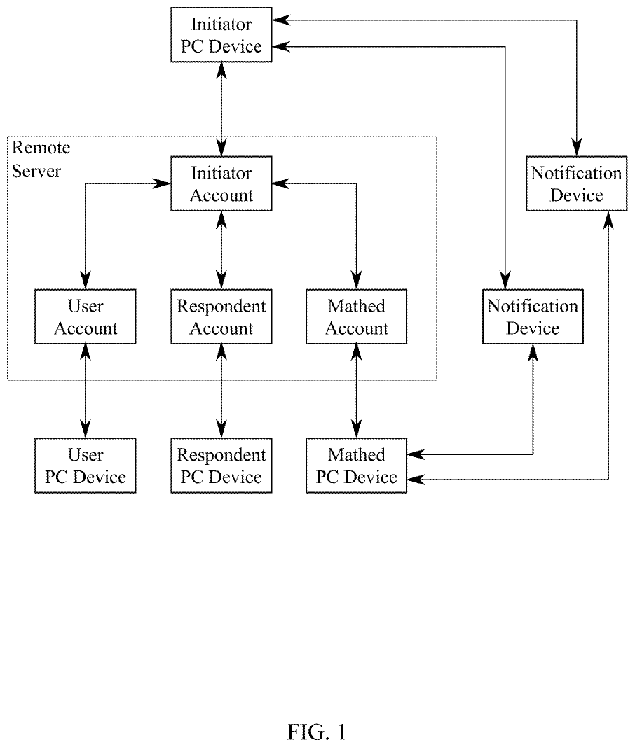

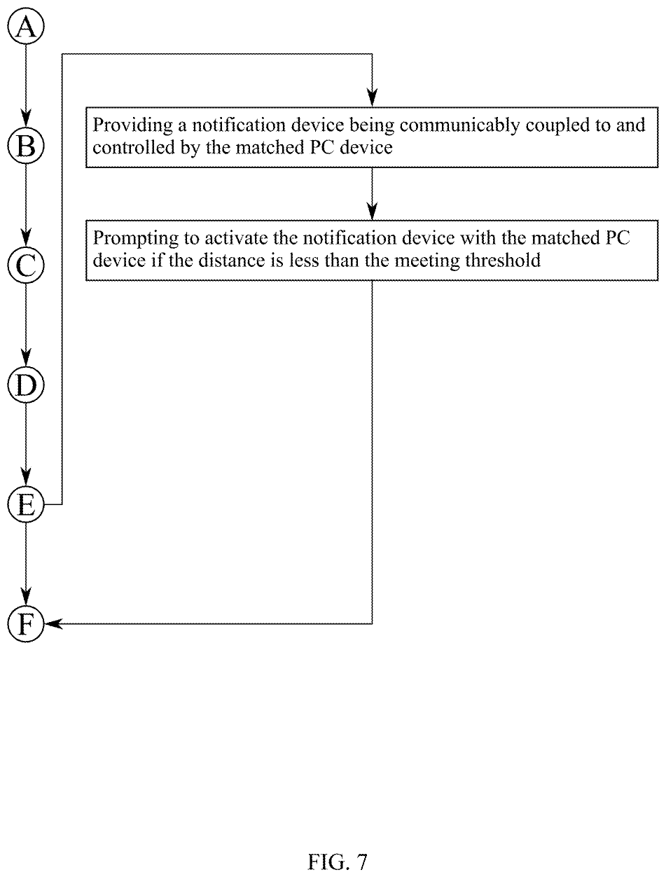

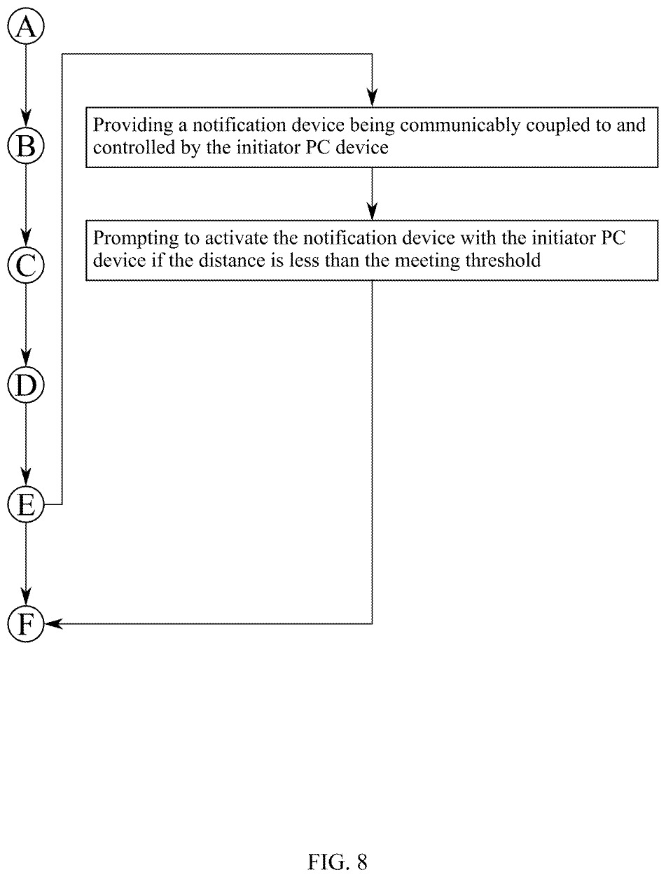

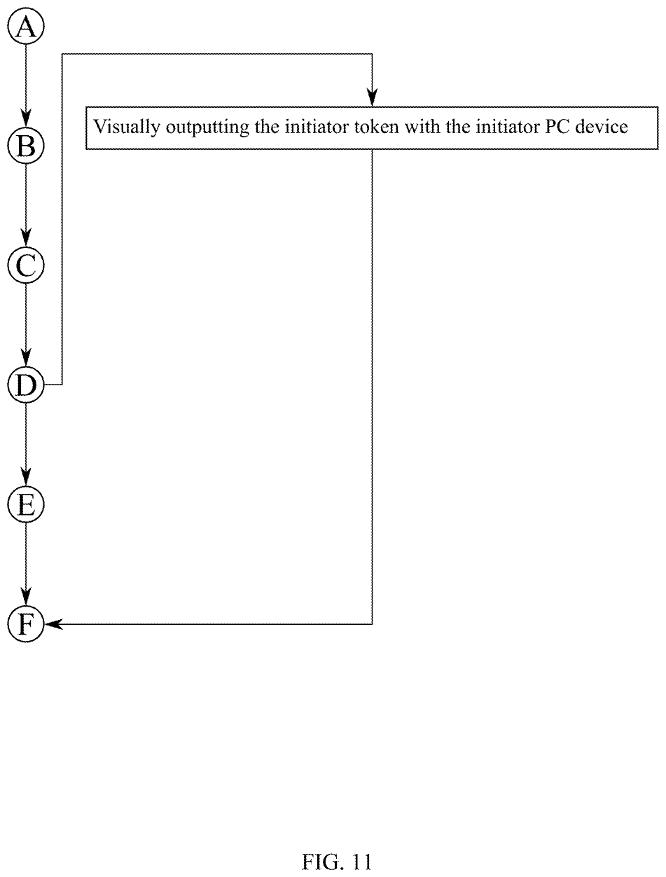

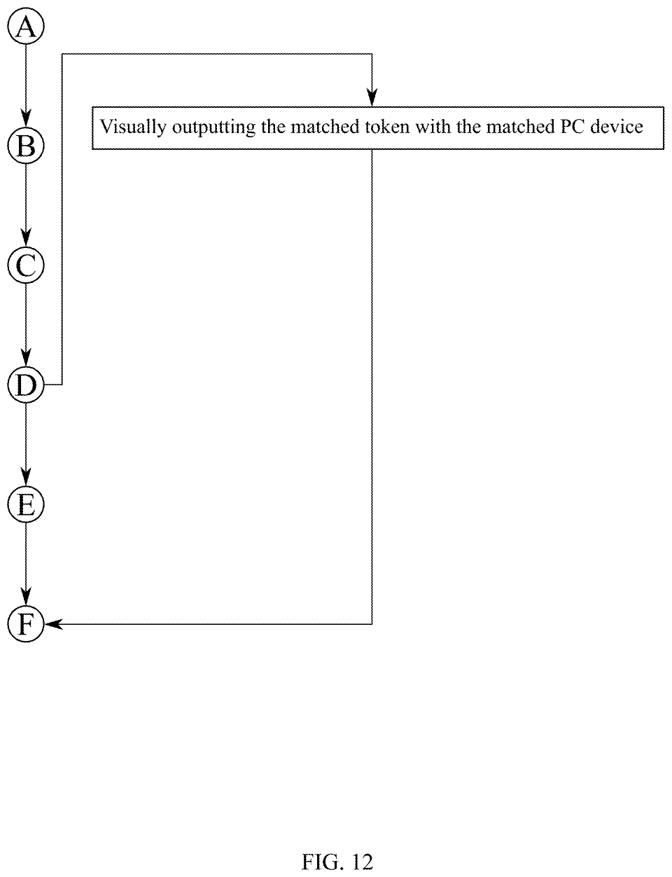

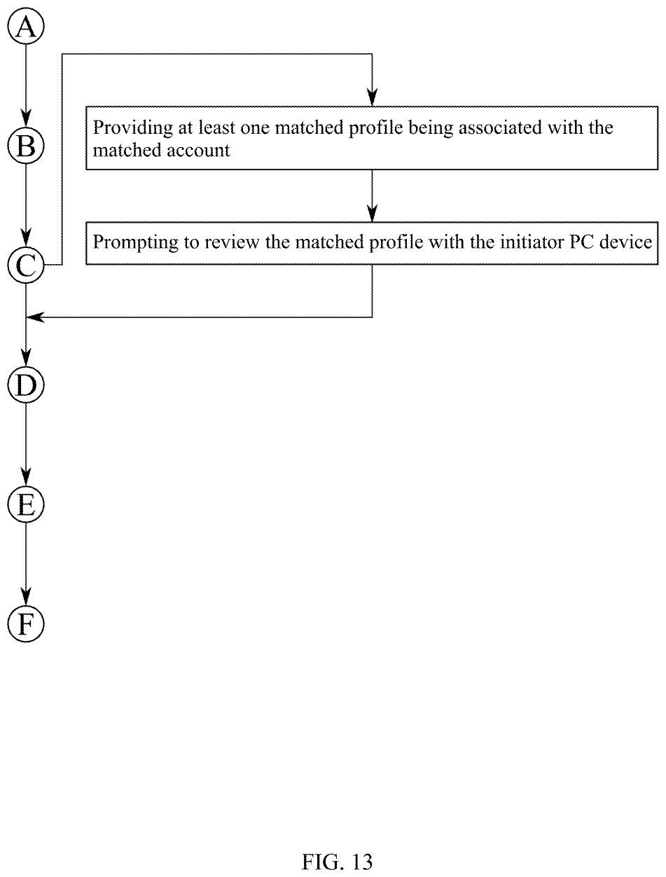

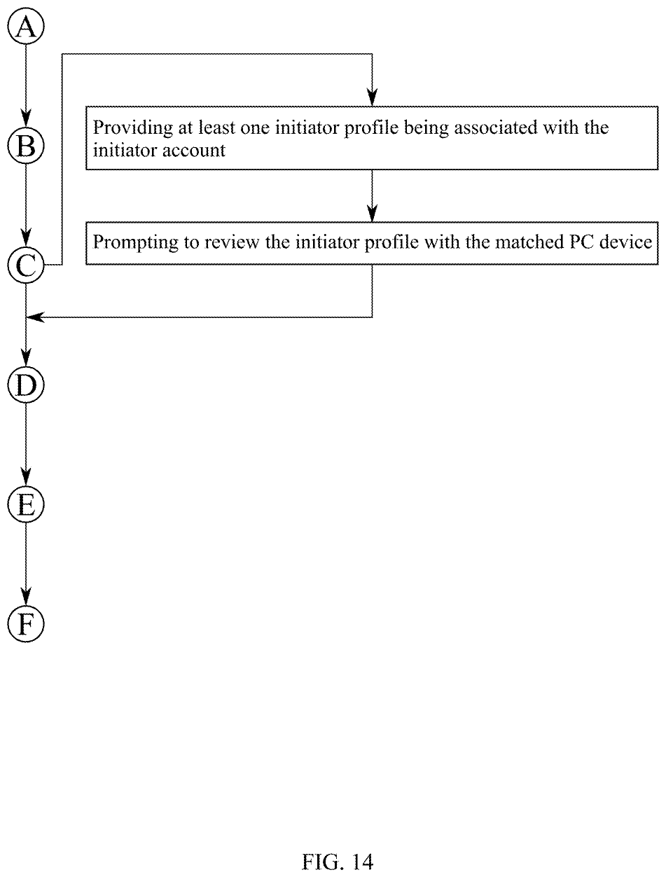

Referring to FIG. 1 through FIG. 15, the preferred embodiment of the present invention is a method for identifying real-world individuals who are connected through a digital platform. The method is designed to increase the safety and efficiency of real-world interactions that are initiated and mediated through digital systems. Further, the method of the present invention employs a system that provides unique identifiers to a user who initiates a request for services or social interaction and a user who responds to the request. This enables the initiator and the respondent to easily identify each other before fulfilling the service request or beginning the social interaction. Thus, limiting the opportunity for either party to interact with an unwanted third party. In one use case, the method of the present invention is designed to enable the initiator to request a paid ride from a contractor or professional driver. In this case, the driver is the respondent and the two parties agree upon a meeting place and a unique token that will be used to differentiate the two interested parties from any unwanted third parties. Preferably, the method of the present invention uses visual tokens to identify the interested parties. However, some embodiments employ various notification strategies, including, but not limited to haptic feedback, audio alerts, and temperature related signaling. In some embodiments, the present invention is designed to be integrated into third-party applications. Thus, the initiator is able to use the present invention to schedule rides through a third-party ridesharing app. Further, the present invention can be used to limit direct communication between the initiator and the respondent by acting as a mediator for all rendezvous negotiations and information sharing.

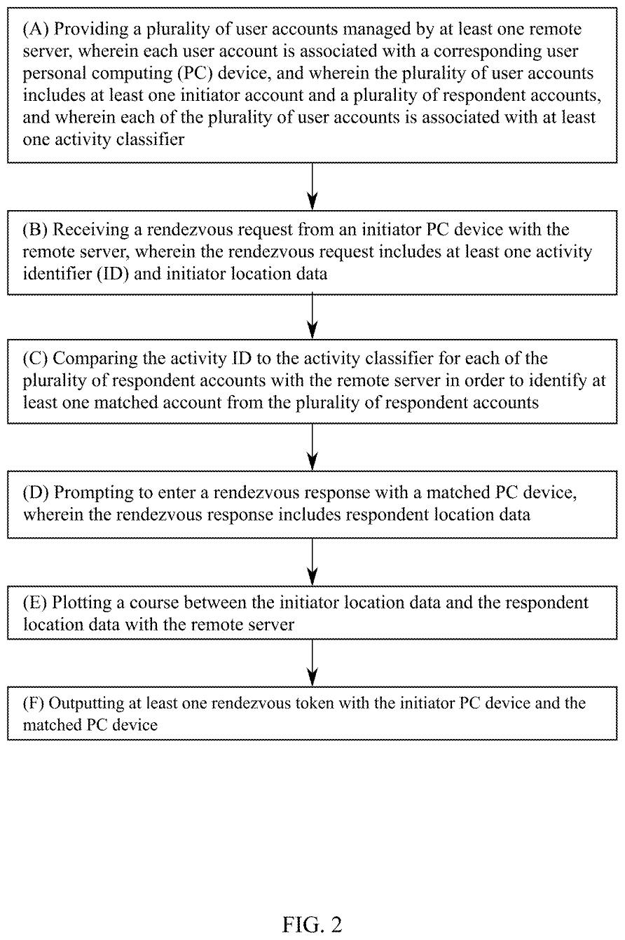

Referring to FIG. 1 and FIG. 2, the system used to execute the method of the present invention allows the present invention to function as a communication tool and physical identification device for multiple users. To accomplish this, the method of the present invention associates each of the plurality of users with a unique user account from a plurality of user accounts that is managed by a remote server (Step A). The plurality of user accounts is divided into at least one initiator account and a plurality of respondent accounts. Each of the plurality of initiator accounts is tied to a single initiator user who is granted permissions that enable the initiator to perform functions including, but not limited to, requesting services and interactions, responding to questions issued by respondent accounts, and generating messages that are transmitted to multiple user accounts. Each of the plurality of respondent accounts is tied to a single respondent user who is only granted sufficient permissions to send messages to initiator accounts that request services interactions and send messages. Each of the plurality of user accounts is associated with a corresponding user personal computing (PC) device. The PC devices used to interact with the present invention can be, but are not limited to, a smart-phone, a laptop, a desktop, or a tablet PC. The term remote server is used herein to describe a data processing system capable of executing background processing, coordinating communication, and managing navigation operations, and storing data for the remaining electronic components of the system. Further, the remote server is used to facilitate communication between the plurality of user accounts. Moreover, the remote server is used to execute a number of internal processes for the present invention and is used to store message data.

The present invention is designed to enable an arbitrary user to switch between different roles while maintaining a single user account. To that end, each of the plurality of user accounts is associated with at least one activity classifier. The activity classifier is used to denote the permissions and roles associated with each user account. For example, an arbitrary user account may be associated with a driver classifier, a rider classifier, and a group member classifier. This collection of classifiers would enable the arbitrary user to selectively switch between performing different activities. In one instance, the arbitrary user is able receive notifications from a previously unknown user requesting a ride. In another instance, the arbitrary user is able to request a ride from a different previously unknow user. Further, the activity classifier is used to identify the types of external users with whom the arbitrary user has permissions to initiate contact. For example, the arbitrary user account may have an activity classifier that identifies the account as private. Thus, the only external accounts that are able to initiate contact with the arbitrary user account will have an activity classifier which denotes these accounts as being part of the arbitrary account's friend group. Preferably, the arbitrary user is able to add and remove activity classifiers from their user account as required.

Referring to FIG. 1 and FIG. 2, the method of the present invention is designed to enable the arbitrary user to act as the initiator or the respondent depending on circumstance. To that end, the overall method of the present invention begins by receiving a rendezvous request from an initiator PC device with the remote server (Step B). The rendezvous request is a message that the initiator generates to initiate communication with at least one external user. Preferably, the user account that generates the rendezvous request is classified as the initiator account and all other user accounts are denoted as respondent accounts. Additionally, the rendezvous request includes at least one activity identifier and initiator location data. Thus, the rendezvous request defines what type of service or interaction the initiator is looking for and the location that the initiator would like the interaction to occur. For example, if the initiator is looking for a ride then the activity identifier will denote this, and the initiator location data will define the place where the initiator wants to be picked up. The overall method of the present invention continues by comparing the activity ID to the activity classifier for each of the plurality of respondent accounts with the remote server in order to identify at least one matched account from the plurality of respondent accounts (Step C). The method of the present invention compares the initiator's request with the activity classifiers associated with each of the remaining user accounts to determine which respondent accounts have the appropriate permissions to act as drivers. Once these user accounts are matched to the initiator's request, they are denoted as matched accounts. In some embodiments, the method of the present invention performs further processing to identify which matched accounts are best positioned to fulfill the rendezvous request. That is, the method of the present invention is designed to select the most appropriate matching accounts using data points, that include but are not limited to, respondent location, price, initiator preference, the respondent's rating, the respondent account's affiliation to the initiator account, and respondent account activity history.

Once the matched account is identified, the overall method of the present invention continues by prompting to enter a rendezvous response with a matched PC device (Step D). The rendezvous response includes respondent location data which is used to calculate the best rout between the initiator and the respondent. Thus, the present invention notifies the matched account of a request that the respondent should be able to fulfill. The respondent account is given the opportunity to bid to fulfill the request or to simply ignore the request. If the respondent account bids to fulfill the request, a rendezvous response will be sent to the initiator account. In some embodiments, a plurality of matched accounts submits rendezvous requests and the initiator is prompted to select the bid that best satisfies the rendezvous request.

Once the rendezvous response is received and accepted by the initiator, the overall method of the present invention continues by plotting a course between the initiator location data and the respondent location data with the remote server (Step E). The method of the present invention is designed to facilitate bring real-world individuals together to perform a variety of services and interaction. Thus, the remote server is tasked with finding the most efficient route to travel when moving between the initiator location and the respondent location. Preferably, the plotted rout compensates for environmental conditions including, but not limited to road conditions, traffic, and weather. In the use case when the initiator is requesting a ride, the method of the present invention will navigate the respondent to the initiator's location, or the location that the initiator requested the rendezvous occur, along the plotted course. In a separate use case, the initiator may request to meeting with the respondent. In this scenario, the initiator may be navigated toward the respondent's location, the respondent may be navigated toward the initiator's location, or the two users may be navigated toward a separate destination. Regardless of the use case, the overall method continues by outputting at least one rendezvous token with the initiator PC device and the matched PC device (Step F). The rendezvous token is a unique identifier that can be recognized by both the initiator and the respondent. Preferably, the rendezvous token is easily discerned via a cursory visual inspection. Accordingly, the rendezvous token may be any type of visual output from the initiator PC device and the respondent PC device including, but not limited to, icons on a screen, patterns on a screen, pictures displayed on a screen, a colored light, a movie clip on a screen, and a screen displaying a single color.

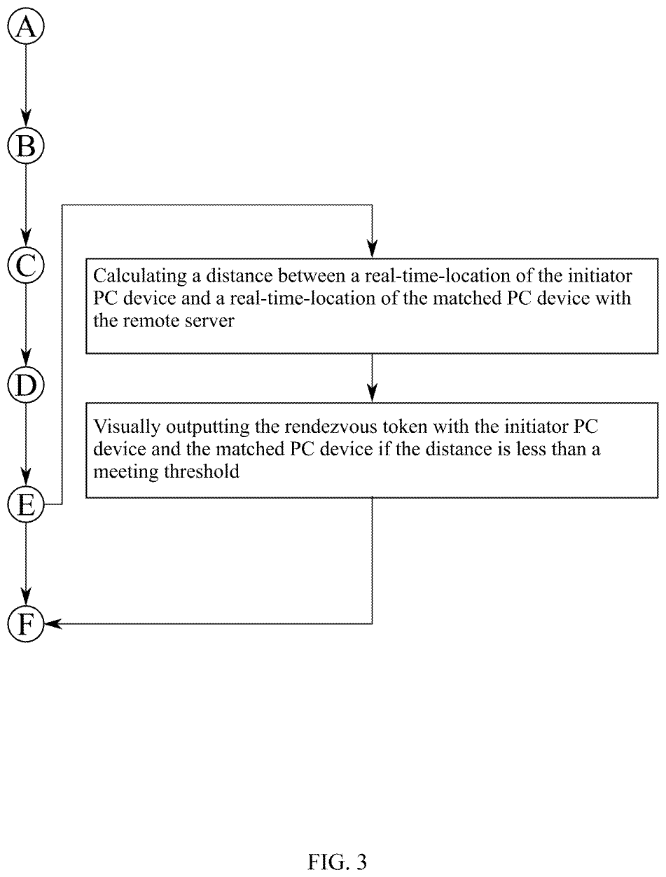

Referring to FIG. 3, the rendezvous token is displayed to alert the initiator and the respondent of each other's presence. Thereby limiting the chance that either party will interact with any unwanted third parties. Once the two parties are moving toward the initiator's desired location, a subprocess of the method of the present invention begins by calculating a distance between a real-time-location of the initiator PC device and a real-time-location of the matched PC device with the remote server. Thus, the method of the present invention maintains a constant awareness of the position of the initiator and the respondent. The subprocess concludes by visually outputting the rendezvous token with the initiator PC device and the matched PC device if the distance is less than a meeting threshold. The meeting threshold is a distance within which the initiator and the respondent are able to visually inspect each other. Consequently, the rendezvous token will be output when the initiator and respondent are within a desired range of each other. Further, the output can be turned off once the two parties have begun the service or desired interaction. To achieve the above described functionality, the initiator device and the respondent device are each preferably equipped with a screen, a speaker, and a location tracking device, such as a GPS sensor.

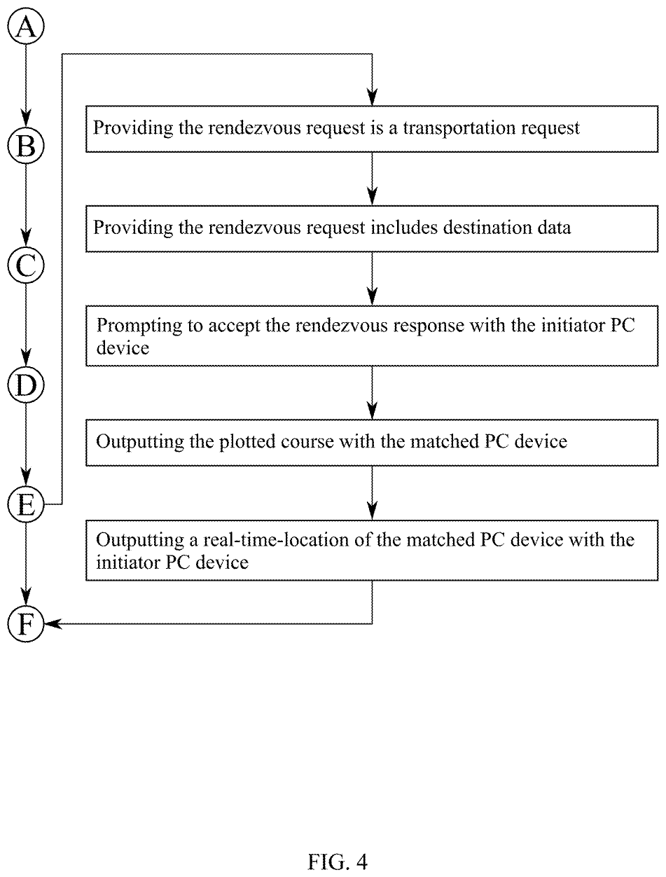

Referring to FIG. 4, as described above, the method of the present invention is designed to enable the initiator to request a ride from a contractor or professional driver. Accordingly, the method of the present invention initiates a ridesharing subprocess when the rendezvous request is a transportation request that includes destination data. The destination data describes the final destination to which the initiator wants to be driven when submitting the ridesharing request. The subprocess begins by prompting to accept the rendezvous response with the initiator PC device. Thus, the initiator is given the option to select from any of the rendezvous responses submitted by the matched accounts. Once the initiator selects the matched account that will drive the initiator to the destination, the subprocess continues by outputting the plotted course with the matched PC device. Thus, both the initiator and the respondent are constantly aware of each other's position. Preferably, the real-time-location of the initiator and the respondent are displayed in an interactive graphical user interface.

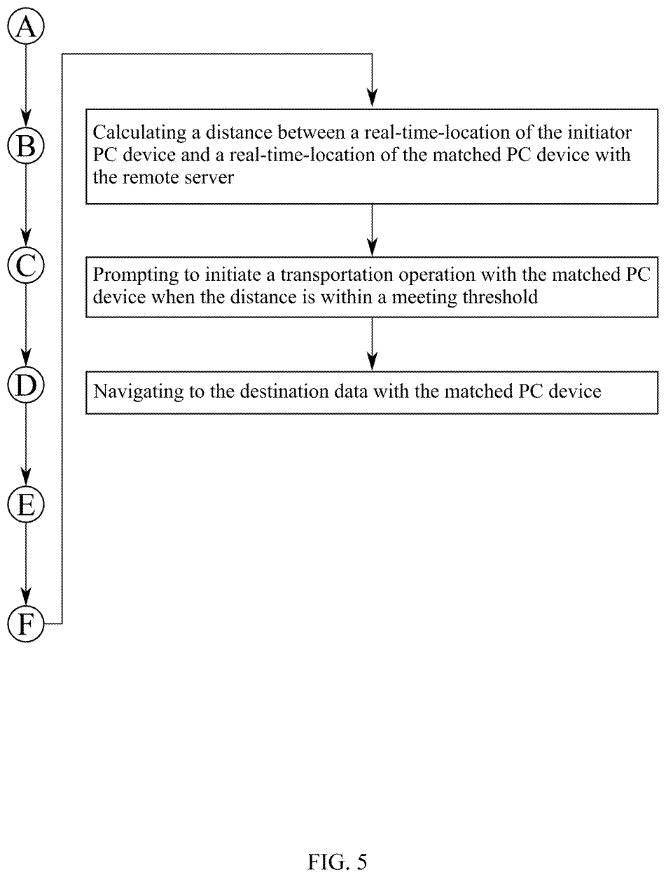

Referring to FIG. 5, the method of the present invention is designed with a subroutine that enables the respondent to quickly begin driving once the initiator is picked up. The subroutine begins by calculating a distance between the real-time-location of the initiator PC device and the real-time-location of the matched PC device with the remote server and continues by prompting to initiate a transportation operation with the matched PC device when the distance is within a meeting threshold. Thus, the respondent is prompted to begin tracking the ride for fare purposes and transitioning from the initial meeting to providing the requested service. The Subroutine continues by gating to the destination data with the matched PC device. Accordingly, the routine is designed to enable the respondent to use the method of the present invention as a navigation tool when transporting the initiator to the destination.

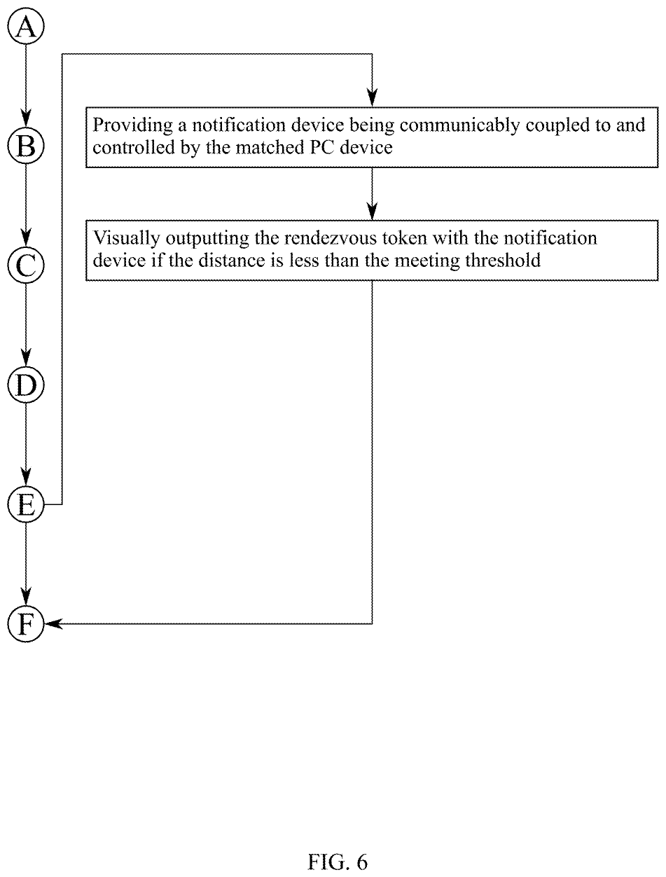

Referring to FIG. 6 through FIG. 8, the present invention is designed to facilitate meetings between two or more individuals. To that end, some embodiments of the system used to execute the present invention further comprise at least one notification device. Preferably, the notification device is an electronic system with an integrated display device wireless communication capability. In some embodiments the notification device includes a camera, a location tracking system, a speaker, and an external mounting device. The notification device is tied to a specific user account from the plurality of user accounts and can be used to output the rendezvous token while under the command of at least one user PC device. The notification device is designed to be mounted onto external surfaces. For example, the notification device may be mounted onto a vehicle, an article of clothing or a building. The notification device is communicably coupled to and controlled by the initiator PC device and the matched PC device and may be controlled by either device. The notification device may be activated to automatically output the rendezvous token if the distance between the initiator and the respondent is less than the meeting threshold. Additionally, the notification device may be activated to output the rendezvous token after receiving a command from the matched PC device. Similarly, the notification device may be activated to output the rendezvous token after receiving a command from the initiator PC device. Thus, the initiator and the respondent are able to make sure to interact with the correct individual.

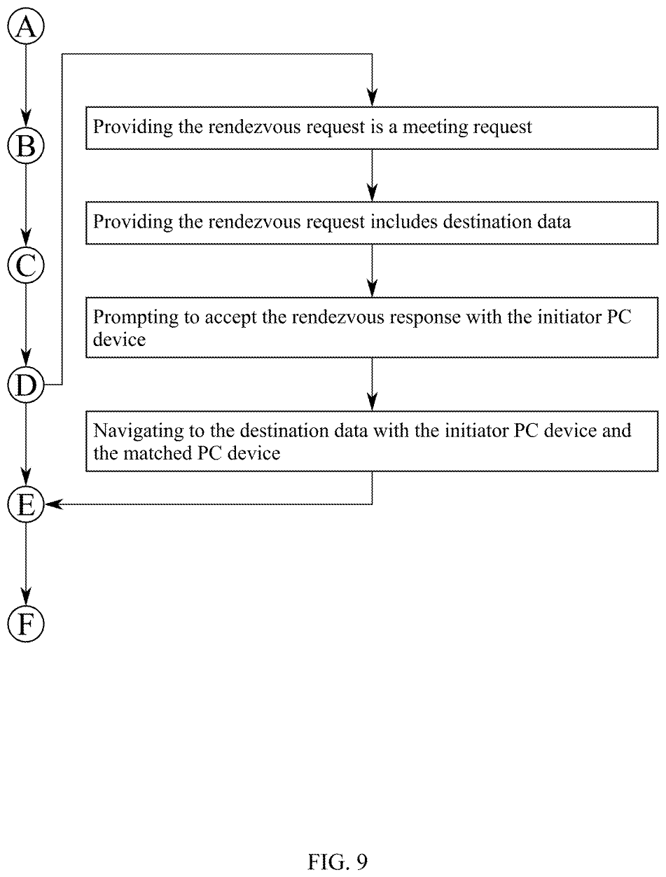

Referring to FIG. 9, the present invention is designed to facilitate various interactions and services. In one use case, the rendezvous request is a meeting request where the initiator wants to rendezvous with at least one respondent without a specified service being performed. The method of the present invention employs a meeting subprocess to facilitate such scenarios. This subprocess begins by prompting to accept the rendezvous response with the initiator PC device. Once the respondent sends the rendezvous response, the two parties are able to communicate and negotiate a desired time and location. The subprocess continues by navigating to the destination data with the initiator PC device and the matched PC device. Accordingly, the subprocess is designed to enable the initiator and the respondent to use the method of the present invention as a navigation tool when transporting the initiator to the destination. In some embodiments, the remote server generates a graphical representation of the real-time-location of the initiator PC device and the real-time-location of the matched PC device. This interface is displayed through the initiator PC device and the matched PC device and used to direct the initiator and the respondent to the meeting destination.

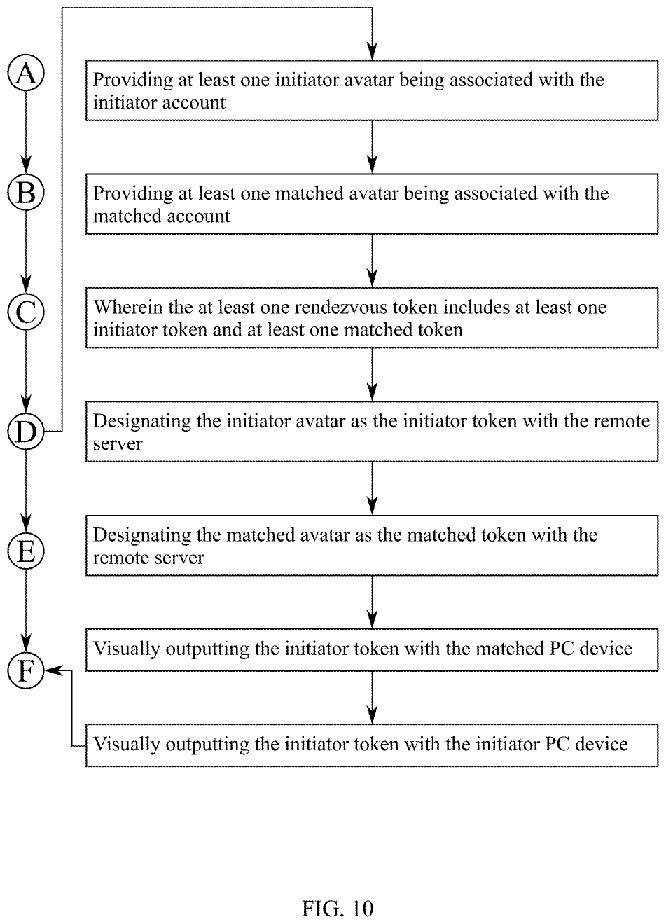

Referring to FIG. 10 through FIG. 14, the present invention enables users to provide personalized information that facilitates identification. Specifically, the present invention enables users to create customized profiles and avatars that can be seen by other users of the service. This enables the method of the present invention to be employed for social interactions that include, but are not limited to, dating, role playing, and organizing events. In some embodiments the initiator account is associated with at least one initiator avatar and an initiator profile. Likewise, the matched account is associated with at least one matched avatar and a matched account. The initiator avatar and the matched avatar are digital representations of the real-world individuals to whom the initiator profile and the matched account are tied. Additionally, the rendezvous token may include at least one initiator token and at least one matched token that are designated as the initiator avatar and the matched avatar, respectively. As a result, the method of the present invention visually outputs the initiator token with the matched PC device when outputting the rendezvous token. Likewise, the method of the present invention visually outputs the matched token with the initiator PC device as a means of outputting the rendezvous token. Similarly, the initiator token may be output with the initiator PC device and the matched token may be output with the matched PC device. Thereby, enabling the initiator and the respondent to know each other's avatars prior to the rendezvous. Further, the initiator PC device and the matched PC device are able to either token as a signal for the rendezvous.

The initiator profile and the matched profile may include personal information that comprises, likes, dislikes, social groups, and sexual orientation. The present invention employs subprocesses that prompt the initiator to view the matched profile with the initiator PC device. Thereby enabling the initiator to access the respondent's personal information. Likewise, the present invention employs subprocesses that prompt the respondent to view the initiator profile with the matched PC device. Thereby enabling the respondent to access the initiator's personal information.

According to some embodiments, methods, systems, apparatuses and devices for facilitating combining of mortgage business and brokerage business to provide financial incentives to real estate buyers are disclosed.

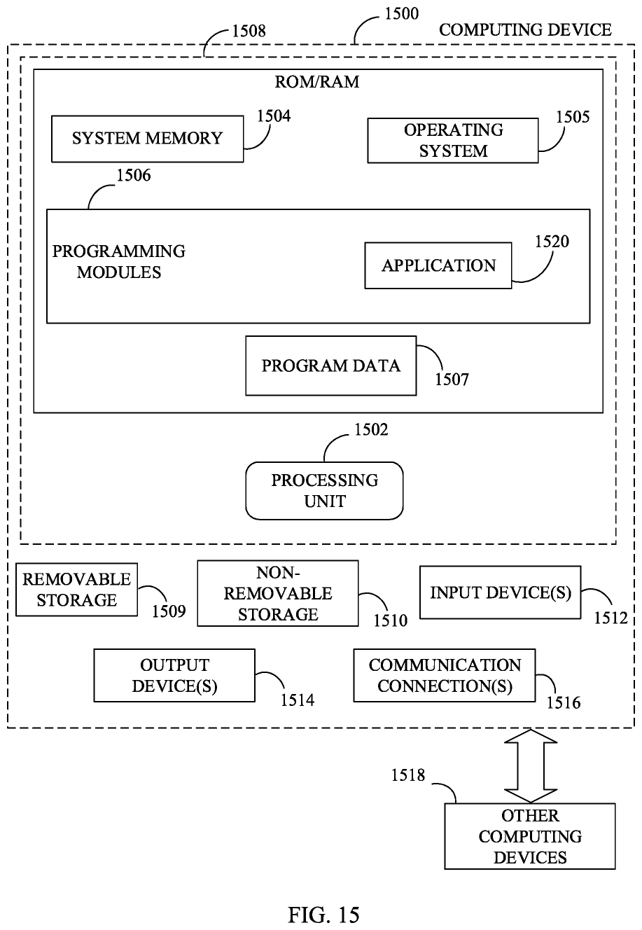

With reference to FIG. 15, a system consistent with an embodiment of the disclosure may include a computing device or cloud service, such as computing device 1500. In a basic configuration, computing device 1500 may include at least one processing unit 1502 and a system memory 1504. Depending on the configuration and type of computing device, system memory 1504 may comprise, but is not limited to, volatile (e.g. random-access memory (RAM)), non-volatile (e.g. read-only memory (ROM)), flash memory, or any combination. System memory 1504 may include operating system 1505, one or more programming modules 1506, and may include a program data 1507. Operating system 1505, for example, may be suitable for controlling computing device 1500's operation. In one embodiment, programming modules 1506 may include image-processing module, machine learning module. Furthermore, embodiments of the disclosure may be practiced in conjunction with a graphics library, other operating systems, or any other application program and is not limited to any particular application or system. This basic configuration is illustrated in FIG. 15 by those components within a dashed line 1508.

Computing device 1500 may have additional features or functionality. For example, computing device 1500 may also include additional data storage devices (removable and/or non-removable) such as, for example, magnetic disks, optical disks, or tape. Such additional storage is illustrated in FIG. 15 by a removable storage 1509 and a non-removable storage 1510. Computer storage media may include volatile and non-volatile, removable and non-removable media implemented in any method or technology for storage of information, such as computer-readable instructions, data structures, program modules, or other data. System memory 1504, removable storage 1509, and non-removable storage 1510 are all computer storage media examples (i.e., memory storage.) Computer storage media may include, but is not limited to, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store information and which can be accessed by computing device 1500. Any such computer storage media may be part of device 1500. Computing device 1500 may also have input device(s) 1512 such as a keyboard, a mouse, a pen, a sound input device, a touch input device, a location sensor, a camera, a biometric sensor, etc. Output device(s) 1514 such as a display, speakers, a printer, etc. may also be included. The aforementioned devices are examples and others may be used.

Computing device 1500 may also contain a communication connection 1516 that may allow device 1500 to communicate with other computing devices 1518, such as over a network in a distributed computing environment, for example, an intranet or the Internet. Communication connection 1516 is one example of communication media. Communication media may typically be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media. The term computer readable media as used herein may include both storage media and communication media.

As stated above, a number of program modules and data files may be stored in system memory 1504, including operating system 1505. While executing on processing unit 1502, programming modules 1506 (e.g., application 1520 such as a media player) may perform processes including, for example, one or more stages of methods, algorithms, systems, applications, servers, databases as described above. The aforementioned process is an example, and processing unit 1502 may perform other processes. Other programming modules that may be used in accordance with embodiments of the present disclosure may include machine learning applications.

Generally, consistent with embodiments of the disclosure, program modules may include routines, programs, components, data structures, and other types of structures that may perform particular tasks or that may implement particular abstract data types. Moreover, embodiments of the disclosure may be practiced with other computer system configurations, including hand-held devices, general purpose graphics processor-based systems, multiprocessor systems, microprocessor-based or programmable consumer electronics, application specific integrated circuit-based electronics, minicomputers, mainframe computers, and the like. Embodiments of the disclosure may also be practiced in distributed computing environments where tasks are performed by remote processing devices that are linked through a communications network. In a distributed computing environment, program modules may be located in both local and remote memory storage devices.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. Embodiments of the disclosure may also be practiced using other technologies capable of performing logical operations such as, for example, AND, OR, and NOT, including but not limited to mechanical, optical, fluidic, and quantum technologies. In addition, embodiments of the disclosure may be practiced within a general-purpose computer or in any other circuits or systems.

Embodiments of the disclosure, for example, may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present disclosure may be embodied in hardware and/or in software (including firmware, resident software, micro-code, etc.). In other words, embodiments of the present disclosure may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a portable computer diskette, a random-access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Embodiments of the present disclosure, for example, are described above with reference to block diagrams and/or operational illustrations of methods, systems, and computer program products according to embodiments of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While certain embodiments of the disclosure have been described, other embodiments may exist. Furthermore, although embodiments of the present disclosure have been described as being associated with data stored in memory and other storage mediums, data can also be stored on or read from other types of computer-readable media, such as secondary storage devices, like hard disks, solid state storage (e.g., USB drive), or a CD-ROM, a carrier wave from the Internet, or other forms of RAM or ROM. Further, the disclosed methods' stages may be modified in any manner, including by reordering stages and/or inserting or deleting stages, without departing from the disclosure.

Although the invention has been explained in relation to its preferred embodiment, it is to be understood that many other possible modifications and variations can be made without departing from the spirit and scope of the invention as hereinafter claimed.

What is claimed is:

1. A method for identifying real-world individuals who are connected through a digital platform the method comprising the steps of:
(A) providing a plurality of user accounts managed by at least one remote server, wherein each user account is associated with a corresponding user personal computing (PC) device, and wherein the plurality of user accounts includes at least one initiator account and a plurality of respondent accounts, and wherein each of the plurality of user accounts is associated with at least one activity classifier;
(B) receiving a rendezvous request from an initiator PC device with the remote server, wherein the rendezvous request includes at least one activity identifier (ID) and initiator location data;
(C) comparing the activity ID to the activity classifier for each of the plurality of respondent accounts with the remote server in order to identify at least one matched account from the plurality of respondent accounts;
(D) prompting to enter a rendezvous response with a matched PC device, wherein the rendezvous response includes respondent location data;
(E) plotting a course between the initiator location data and the respondent location data with the remote server;
(F) outputting at least one rendezvous token with the initiator PC device and the matched PC device;

2. The method for identifying real-world individuals who are connected through a digital platform as claimed in claim 1 comprising the steps of:
calculating a distance between a real-time-location of the initiator PC device and a real-time-location of the matched PC device with the remote server;
visually outputting the rendezvous token with the initiator PC device and the matched PC device if the distance is less than a meeting threshold;

3. The method for identifying real-world individuals who are connected through a digital platform as claimed in claim 1 comprising the steps of:
providing the rendezvous request is a transportation request;
providing the rendezvous request includes destination data;
prompting to accept the rendezvous response with the initiator PC device;
outputting the plotted course with the matched PC device;
outputting a real-time-location of the matched PC device with the initiator PC device;

4. The method for identifying real-world individuals who are connected through a digital platform as claimed in claim 3 comprising the steps of:
calculating a distance between a real-time-location of the initiator PC device and a real-time-location of the matched PC device with the remote server;
prompting to initiate a transportation operation with the matched PC device when the distance is within a meeting threshold;
navigating to the destination data with the matched PC device;

5. The method for identifying real-world individuals who are connected through a digital platform as claimed in claim 3 comprising the steps of:
providing a notification device being communicably coupled to and controlled by the matched PC device;
visually outputting the rendezvous token with the notification device if the distance is less than the meeting threshold;

6. The method for identifying real-world individuals who are connected through a digital platform as claimed in claim 3 comprising the steps of:
providing a notification device being communicably coupled to and controlled by the matched PC device;
prompting to activate the notification device with the matched PC device if the distance is less than the meeting threshold;

7. The method for identifying real-world individuals who are connected through a digital platform as claimed in claim 3 comprising the steps of:
providing a notification device being communicably coupled to and controlled by the initiator PC device;
prompting to activate the notification device with the initiator PC device if the distance is less than the meeting threshold;

8. The method for identifying real-world individuals who are connected through a digital platform as claimed in claim 1 comprising the steps of:
providing the rendezvous request is a meeting request;
providing the rendezvous request includes destination data;
prompting to accept the rendezvous response with the initiator PC device;
navigating to the destination data with the initiator PC device and the matched PC device;

9. The method for identifying real-world individuals who are connected through a digital platform as claimed in claim 1 comprising the steps of:
providing at least one initiator avatar being associated with the initiator account;
providing at least one matched avatar being associated with the matched account;
wherein the at least one rendezvous token includes at least one initiator token and at least one matched token;
designating the initiator avatar as the initiator token with the remote server;
designating the matched avatar as the matched token with the remote server;
visually outputting the initiator token with the matched PC device;
visually outputting the matched token with the initiator PC device;

10. The method for identifying real-world individuals who are connected through a digital platform as claimed in claim 9 comprising the steps of:
visually outputting the initiator token with the initiator PC device;

11. The method for identifying real-world individuals who are connected through a digital platform as claimed in claim 9 comprising the steps of:
visually outputting the matched token with the matched PC device;

12. The method for identifying real-world individuals who are connected through a digital platform as claimed in claim 1 comprising the steps of:
providing at least one matched profile being associated with the matched account;
prompting to review the matched profile with the initiator PC device;

13. The method for identifying real-world individuals who are connected through a digital platform as claimed in claim 1 comprising the steps of:
providing at least one initiator profile being associated with the initiator account;
prompting to review the initiator profile with the matched PC device;
